(19) United States
(12) Patent Application Publication
(10) Pub. No.: US 2023/0393538 A1
(43) Pub. Date: Dec. 7, 2023

(54) Method and System for Event Handling in Industrial Process Automation

(71) Applicant: ABB Schweiz AG, Baden (CH)

(72) Inventors: Dawid Ziobro, Vasteras (SE); Jens Doppelhamer, Ladenburg (DE); Benedikt Schmidt, Heidelberg (DE); Simon Hallstadius Linge, Vasteras (SE); Gayathri Gopalakrishnan, Eskilstuna (SE); Pablo Rodriguez, Ilvesheim (DE); Benjamin Kloepper, Mannheim (DE); Reuben Borrison, Schwetzingen (DE); Marcel Dix, Allensbach (DE); Hadil Abukwaik, Weinheim (DE); Arzam Muzaffar Kotriwala, Ladenburg (DE); Sylvia Maczey, Hirschberg (DE); Marco Gaertler, Dossenheim (DE); Divyasheel Sharma, Bangalore (IN); Chandrika K R, Bangalore (IN); Matthias Berning, Worms (DE)

(73) Assignee: ABB Schweiz AG, Baden (CH)

(21) Appl. No.: 18/452,313

(22) Filed: Aug. 18, 2023

Related U.S. Application Data
(63) Continuation of application No. PCT/EP2022/054083, filed on Feb. 18, 2022.

(30) Foreign Application Priority Data
Feb. 19, 2021 (EP) 21158145.9

(51) Int. Cl. G05B 13/02; G05B 23/02

(52) U.S. Cl. CPC G05B 13/0265; G05B 23/0216; G05B 2223/02

(57) ABSTRACT

A method for providing a solution strategy for a current event in industrial process automation includes monitoring a process for events and recording manual user action data, upon occurrence of an event, acquiring the recorded data regarding manual user actions before, during, and after the occurrence of the event, learning a procedure for handling the event based on the acquired data, and applying the learnt procedure to a currently occurring event.

### CROSS-REFERENCE TO RELATED APPLICATIONS

The instant application claims priority to International Patent Application No. PCT/EP2022/054083, filed Feb. 18, 2022, and to European Patent Application No. 21158145.9, filed Feb. 19, 2021, each of which is incorporated herein in its entirety by reference.

### FIELD OF THE DISCLOSURE

The present disclosure generally relates to a computer-implemented method for handling a current event in industrial process automation, a system comprising a controller configured to handle the event, a program element, a computer readable medium, and a use.

### BACKGROUND OF THE INVENTION

In an industrial process automation, the processes are monitored so that events or alarms such as exceeding a valid range of a processing value, for example a level of a liquid in a vessel, is displayed to an operator. In many cases, such events are caught by pre-defined standard routines. However, this is not always possible. For example, there are events or alarms, or there are conditions under which events occur that are not covered by such procedures. Thus, for these cases no automatic procedures exist, and an operator must find a solution and perform the found strategy manually. Further, a human may not find a preferable solution due to the complexity if several aspects must be considered.

### BRIEF SUMMARY OF THE INVENTION

There may be a desire to improve the handling of alarms and events in an industrial process automation system. The described embodiments pertain to a computer-implemented method for providing a handling of an event in industrial process automation, the system comprising a controller configured to handle the event, the program element and the computer readable medium. Synergetic effects may arise from different combinations of the embodiments although they might not be described in detail.

Further on, it shall be noted that all embodiments of the present invention concerning a method, might be carried out with the order of the steps as described, nevertheless this has not to be the only and essential order of the steps of the method. The herein presented methods can be carried out with another order of the disclosed steps without departing from the respective method embodiment, unless explicitly mentioned to the contrary hereinafter.

Technical terms are used by their common sense. If a specific meaning is conveyed to certain terms, definitions of terms will be given in the following in the context of which the terms are used.

According to a first aspect, a computer-implemented method for handling a current event in industrial process automation is provided. The method comprises the steps monitoring a process for events and recording manual user action data, upon occurrence of an event, for example, of an event type, acquiring the recorded data regarding manual user actions before, during, and after the occurrence of an event, of e.g., the event type, learning a procedure for handling an event, of e.g., the event type, based on the acquired data, wherein the learning involves creating and providing a solution strategy and collecting user evaluation data for the provided solution strategy, and applying the learnt procedure to a currently occurring event, of e.g., the event type.

In other words, a handling or a strategy and application of the strategy for a currently occurring event is provided. The term “event” is used here for an event of an event type that may re-occur several times whereas a “currently occurring event” is a single event under investigation, i.e. which is just happening and has now to be handled. An event type may be a category into which similar single events are grouped. For example, if a fill level is at a maximum, the corresponding threshold of the parameter “fill level” is reached. The threshold may differ dependent on a container type or an application.

If or when there is no automatic event handler, the occurrence of an event is indicated to the user, e.g., an operator, who has to react upon the event manually. In embodiments of the invention, by the computer-implemented method, the reaction of the user is recorded so that if an event re-occurs, the controller or the program can access the recorded actions and propose the recorded actions as the solution strategy. The computer-implemented method may be implemented as a machine learning program or artificial intelligence program that finds pattern from operator actions and learns from the user actions and from the feedback of the operator when the event occurs repeatedly. The learning and the strategy may be provided separately for distinct events, i.e., event types. In this case, the event types are pre-defined, and the algorithm of the computer-implemented method is so-to-say downstream or local with respect to the event type. However, the algorithm may also detect event types such that conditions lead to machine-learnt and detected event types without pre-defining such types. Preferably, the learning is supervised. The automated system thus learns from user evaluation and can suggest more appropriate and optimal solution strategies. The system may be a system in an industrial park or facility or an industrial plant.

In accordance with disclosed embodiments, samples comprising values related to a process are recorded. The samples may be sampled analog or digital sensor output data of the process itself, such as fill level, temperature of a medium, composition of medium, mixing state of a medium consisting of different substances, voltages, currents, electrical resistances, conductivities, capacities, actuator states etc. The samples may include time data such as time stamps from a time sensor such as a clock and environmental data such as temperature, humidity, light intensity, etc. That is, one or more sensors acquire, and output data related to the process. Each output is associated to a parameter that is related to the process, also referred to as process parameter. The values of the process parameters at a given time represent the process state at this point of time.

It is noted that also detectors to detect a state of an actuator such as a valve or a switch is understood under the term “sensor”. An event may occur when one of the process parameters exceeds or falls below a threshold. When being in the learning phase of the machine learning system, in this case, a user will provide an action that is detected and recorded by the system. For that, the system comprises sensors, which may also include detectors, that sense a voltage a user has set, a resistance of a potentiometer, a digital input value that represents for example a timer value or set points such as a threshold for one or more of the process parameters.

The sensed user input data is related to the process data. For that, the system comprises circuitry that, for example, correlates the sensed input data with the process data. The correlation may include process values only or a time relation. For example, exceeding a fill level threshold may always result in opening a valve, independent of the time. Or the time between reaching thresholds or until a user action is performed, etc., may be taken into account. Of interest, however, is not only the process data at the point of time when the event occurs, but of interest is also the development over time. For example, how the gradient of the process parameter was before the event occurred and how the process parameter evolved after the user input, etc. The sensed user input is the solution strategy of the user. The user solution strategy can therefore be regarded as a sequence of operator actions that can be executed to change the process state.

The input for the machine learning system are the process parameters and the user actions. That is, the user input is learnt. The corresponding expression for the output of the machine learning system is the “proposed solution strategy”, which is also referred to as “solution strategy” in this disclosure, which therefore is the solution strategy proposed by the machine learning system. That is, the solution strategy comprises the learnt settings of thresholds, the setting of switches, the points of time or timer intervals when to apply the settings, etc.

Similar to the user solution strategy, the solution strategy proposed by the machine learning system can be regarded as a sequence of proposed actions that can be executed to change the process state. However, the learning may be supervised. For that, the proposed solution strategy is evaluated by the operator or “user”. The user evaluation is a score or rating the operator gives to a solution strategy in the context of the process situation that the solution strategy was supposed to solve. It's the feedback of the operator how well suited the strategy was for the process situation at hand, given a set of KIPs. It is added to the process state descriptive features and the solution strategy features as part of the knowledge base.

The user evaluation data is used to rank the applicable solutions strategies that the algorithm may suggest to the operator in similar process situations. The evaluation, which is represented by the evaluation data, is collected from the user or operator input. The evaluation may be based on an algorithm that takes one or several input parameters, each representing, for example, a KPI. Thereby, the values of the input parameters are not binary but, for example, numbers of an interval, such that a fine tuning of the learning is possible. The different KPI parameters or other evaluation parameters or features may be weighted and biased. Another type of evaluation data is also a score on the overall output of the machine learning system or proposed solution strategy. Further, the machine learning system may output not only one solution strategy but also two, three, or more. The machine learning system may output the solution strategies in an ordered way. That is, with the above-mentioned ranking. The user or operator may evaluate each of these solution strategies and give this feed-back to the machine learning system.

It is therefore vital for proposing a solutions strategy by the machine learning system to receive evaluation data due to the complexity of an event represented by process parameters. There may be numerous solution strategies corresponding to varying user actions that can be applied to reach a stable process condition. For example, previous user actions may have been provided by a novel operator that does not, for example, solve the unstable condition for example in energy efficient manner, or stresses the machines, or uses substances that are costly. Therefore, evaluation and providing the evaluation as feedback on the solution strategy is important, so that one or several process control goals or KPIs can be fulfilled more efficiently. This allows the ML model receiving input to refine the solutions strategies and hence provide efficient solutions that is appreciated and used by the operator.

### BRIEF DESCRIPTION OF THE SEVERAL VIEWS OF THE DRAWING(S)

FIG. 1 shows a flow diagram of the method according to an embodiment.

FIG. 2 shows a more detailed flow diagram of embodiments.

FIG. 3 shows schematically a visualization illustrating the method.

FIG. 4 shows a block diagram of the system according to an embodiment.

### DETAILED DESCRIPTION OF THE INVENTION

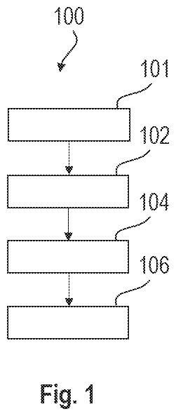

FIG. 1 shows a flow diagram of the computer-implemented method 100 for providing a solution strategy for a current event of an event type in industrial process automation. The method comprises a first step 101 monitoring a process for events and recording manual user action data. In a second step 102, upon occurrence of an event, the recorded data regarding manual user actions before, during, and after the occurrence of an event of the event type is acquired. In a third step 104, a procedure for handling an event of the event type based on the acquired data is learnt, wherein the learning involves creating and providing a solution strategy and collecting user evaluation data for the provided solution strategy. In a fourth step 106, the learnt procedure is applied to a currently occurring event.

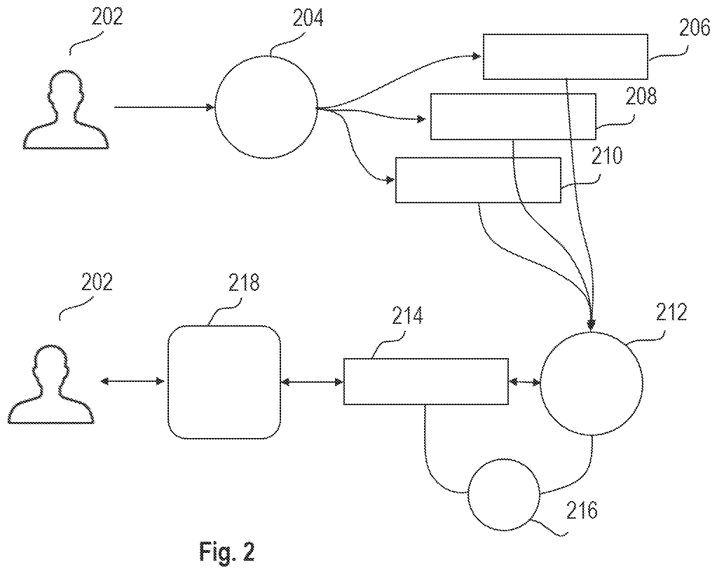

FIG. 2 shows a diagram describing system components and the flow of the computer-implemented method in more detail. A control room operator 202 uses a control operations system 204. During use of the system 204, alarms and events occur 206, which are responded by operator actions 206. For example, the operator 202 modifies process values. The alarms and events may be identified by a type or number and have parameters associated. Such parameters may be the process value itself and limits or valid ranges of the process value, time parameters, etc. An alarm or event may occur, for example, when a process value exceeds a valid range or if a state, for example, the state of a valve is changed. The alarms and events 206 and the associated operator actions 208 and process values 210 are input to machine learning system 212. The machine learning system 212 generates one or more solution strategies 214, which are visualized in an HMI 218, and which is graded by the control room operator 202 giving the feedback to the machine learning system 212. The grading for the solution strategy for the current alarm/event is stored, optionally together with the alarms and events 206, operator actions 208 and process values 210, in a database 216 so that the machine learning system can consider them when calculating the solution strategies for coming alarms/events of the same or similar type.

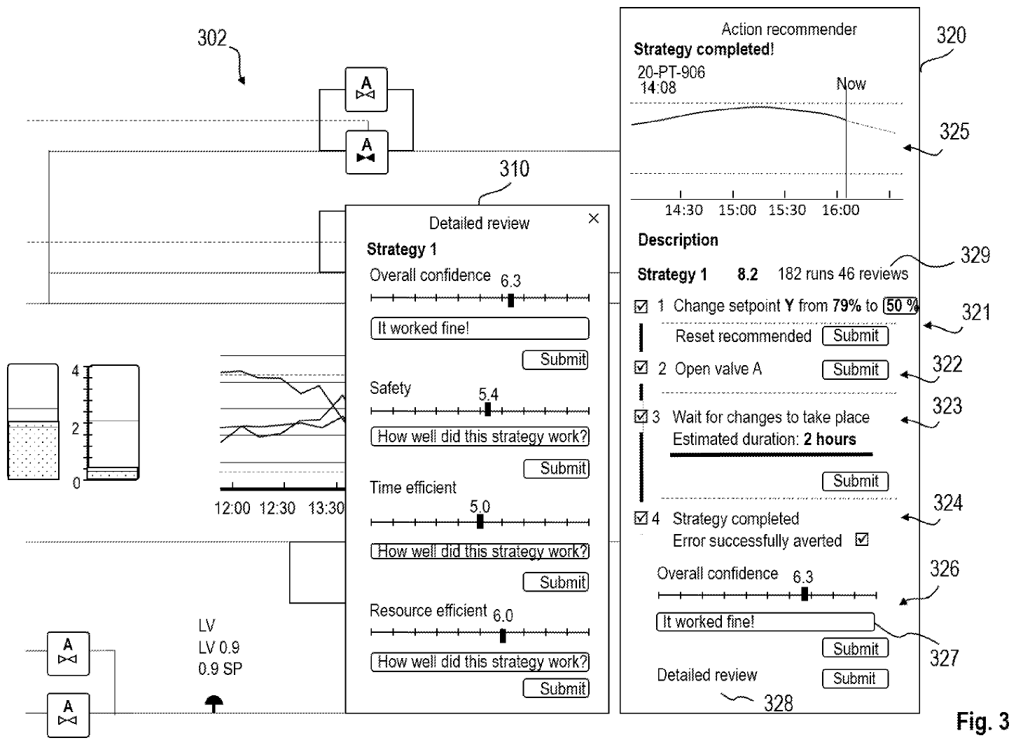

FIG. 3 shows a composed diagram illustrating the grading and a proposed strategy in more detail. The diagram may be a portion of a display of an HMI 218 that interfaces to a control room operator 202 during the learning phase of the machine learning system 212. In the background 302 in FIG. 3, the process is displayed with process states, analyses including time evaluations over time, and system diagrams. The design of the pop-up windows 310, 320 and the background 302 is only an illustrative example and does not limit the scope of the invention.

Pop-up window 320 shows an example of a strategy, in which in a first step 321 a set point value Y is modified from 79% to 50%. In a second step 322, valve A is opened. In a third step 323, it is waited for changes to take place, for example for two hours, and finally, in a fourth step 324, the strategy is completed. In the example, the error has been successfully averted. The top diagram 325 shows the course of the process value that returns back to the middle of the allowed span after about one hour after start of the measure, i.e., change of the set point at 14:08. In this window 320, the operator also has the possibility to interact with the system, and to grade the strategy 326, including providing a comment 327. Especially, the operator can open a further pop-up window 310 to provide a more detailed review 328 that may correspond to technical or economical KPIs. The operator may confirm each step 321, 322, 323, 324 individually by pressing a “submit”-button next to the step or may accept the complete strategy. Furthermore, the frequency how often the strategy has been run and reviewed is displayed 329. In a higher-level menu, further strategies may be selected.

In Pop-up window 310, the operator is requested to give a detailed review of the proposed strategy. The review may be conducted, for example, when the effect of the strategy is visible, which may be, for example, after some minutes or even some hours after applying the strategy, depending on the process. For example, the operator can grade the safety aspect, the time efficiency, and the resource efficiency of the proposed solution strategy, as well as the overall confidence of the measure. Further annotations such as how well the strategy worked can be typed in.

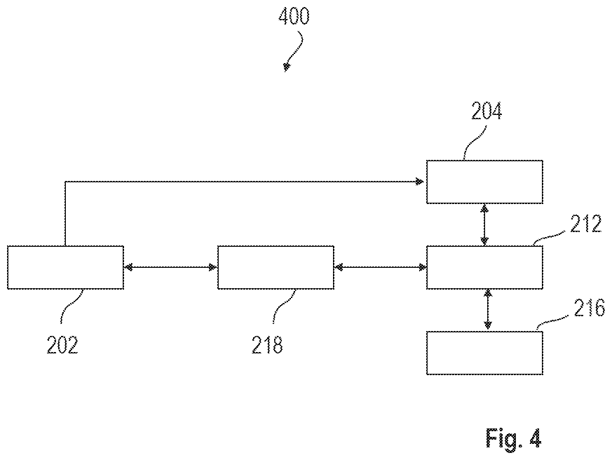

FIG. 4 shows a block diagram of the system 400 with the components shown in FIG. 2. The operator 202 in its role as human system component controls and performs actions to the process devices 204 such as devices, actuators, drivers, sensors etc. The actions are input to the controller 212 on which the machine learning program is implemented. The solution strategies and the associated grades are stored in database 216. The HMI 218 displays the solution strategy, and allows the operator controlling the strategy and inputting grades, comments, etc.

Other variations to the disclosed embodiments can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

In the embodiments described herein, the machine learning system may be represented by a neural network. A neural network is a series of nodes, or neurons. Within each node is a set of inputs, weight, and a bias value. The “learning” in such networks is usually performed by setting weights, which are the parameter within a neural network that transforms input data within the network's hidden layers.

Storage of data such as processing data, sensed user input, and evaluation data may be performed by accessing, i.e., writing and reading, storage mediums and data containers that may be organized as two- or more-dimensional tables, as databases, or in any other way known by a skilled person.

The explanations given above are further embodied in the following. The term “user” is used as a synonym for “operator” in this disclosure. Further, the term “event” shall be interpreted to address also alarms.

According to an embodiment, the learning involves creating and providing a learning phase solution strategy and collecting user evaluation data for the provided solution strategy.

The user evaluation data is, for example, a rating or grading of the strategy provided by the user. The method hence comprises proposing a solution strategy, for example, in the learning phase, where the user evaluates and rates the strategy. As a result, the evaluation data, e.g., grades, are provided by the user as input to the learning step. That is further, instead of feeding back only “right” or “wrong”, a number on a scale is fed back as supervising input to the learning algorithm.

According to an embodiment, the evaluation data, because of the evaluation, is based on pre-defined process Key Performance Indicator (KPI) criteria. There may be several aspects or criteria to which the solution strategy may be optimized. Such criteria may be for example of technical or of economic nature. Due to the complexity and size of the industrial process, each part, i.e., each criterion requires a separate evaluation and balancing of process and business objectives, where human input is crucial.

According to an embodiment, the pre-defined process KPI criteria is one of: time to solve the problem, cost effectiveness, and/or amount of process value (PV) changed.

The time to solve the problem may have influence on other processes or process parts or may be critical with respect to the quality of the product or may extend a process and therefore be costly. The cost effectiveness may depend on parameters such as time, energy or resources in general, or whether human intervention or decision-making may be required. The amount of process value (PV) changed may also have an impact on resources such as energy and time to solve the problem.

According to an embodiment, the acquiring data comprises further acquiring data of system behavior in reaction to the user actions. That is, the learning may include the observing and evaluating the behavior of the system. E.g., it may observe and evaluate criterions such as whether the wanted results are achieved or not, or whether parameter values converge, the time required to obtain the desired process values, energy consumption, and other process parameters. This evaluation is then taken into account when proposing a strategy and in the learning process.

According to an embodiment, the evaluation is based on user-defined criteria. The user-defined criteria may be additional criteria or may be criteria that replace the pre-defined criteria. This means that the user can define, for example, by means of a human-machine-interface, one or more criteria that may be specific for an event type. A criterion may be one of the above-mentioned or a further one. Vice versa, the user may also have the possibility to remove a pre-defined criterion. Further, he may add comments or annotations, which may also be evaluated by an algorithm and considered in the learning process.

According to an embodiment, the evaluation data includes separate ratings for parts of the solution strategy. The strategy may comprise several parts or steps. The user may provide an overall rating for the solution strategy proposed by the program, or a rating for each or for some of the steps. Each rating may comprise a rating for the KPIs or an overall rating over all KPIs. Thus, several combinations may be possible. For example, the solution may be rated with regard to a single KPI may be rated over all steps, a step may be rated over all KPIs or over all KPIs, or any other combination.

According to an embodiment, a frequency of previously chosen solution strategies is evaluated and considered for proposing the solution strategy for the current event. In other words, a histogram or another statistical means is used to evaluate the selection of a strategy for an event type, which is considered for proposing the solution strategy for the current event.

According to an embodiment, the solution strategy comprises at least one step, wherein the step is one of: changing a set point, controlling an actuator, defining wait time intervals and checking a final process result. These steps are a selection out of a plurality of possible step. The solution strategy may therefore comprise further, and more detailed steps. For example, after the steps defining wait time intervals and check of result, there may be options how to proceed in dependence on result parameters. For example, Steps of a strategy solution ranked in a second place may be performed, if the results of the first strategy were not successful.

According to an embodiment, the process value is at least one of the following: a fill level, a pressure, a temperature, a current, a voltage, a fluid mixing state, an actuator state, a system state.

Electrical parameters may further comprise resistance, conductance, impedance and further parameters describing a state of a high or low frequency transmitter or receiver, or the state of devices, including switching states, current settings, and mechanical deficiencies such as pollution of a device, e.g., an antenna, and corrosion.

According to an embodiment, additionally alternative solution strategies are proposed. That is, the machine-learning program may provide one or more solution strategies to handle a current event. The possible solution strategies are ranked and may be displayed, such that an operator may observe the override the actually selected solution strategy ranked at first place.

According to an embodiment, the solution strategy, the solution strategy frequency and the solution strategy evaluation data are visualized. The visualization supports the user with information to supervise the process.

According to a second aspect, a system, e.g., in an industrial park or facility or an industrial plant, comprising a controller configured to handle a current event in industrial process automation according to a method as described herein.

The system may further comprise a Human Machine Interface (HMI). The visualization may be realized by means of a display being a part of the HMI. The display may be a touch-screen display for receiving ratings and annotations. The HMI may further comprise a keyboard, optical and acoustical means, etc. The system may be a system.

According to a further aspect, a computer program element is provided, which when being executed by a controller of the system, instructs the system to perform the steps of the computer-implemented method.

As discussed before, the methods are computer-implemented. The invention therefore also relates to one or more computer programs with machine-readable instructions that, when executed on one or more computers and/or compute instances, cause the one or more computers to perform a method described above. In this context, a virtualization platform, a hardware controller, network infrastructure devices (such as switches, bridges, routers or wireless access points), as well as end devices in the network (such as sensors, actuators or other industrial field devices) that are able to execute machine readable instructions are to be regarded as computers as well.

The computer program element may be part of a computer program, but it can also be an entire program by itself. For example, the computer program element may be used to update an already existing computer program to get to the present invention.

The controller may comprise circuits without programmable logics or may be or comprise a micro controller, a field programmable gate array (FPGA), an ASIC, a Complex Programmable Logic Devices (CPLD), or any other programmable logic devices known to person skilled in the art.

According to a further aspect, a computer readable medium is provided on which such a program element is stored. The computer readable medium may be seen as a storage medium, such as for example, a USB stick, a CD, a DVD, a data storage device, a hard disk, or any other medium on which a program element as described above can be stored.

Thus, an automated system and method are provided to identify patterns in plant operator actions to solve issues. The automated system learns from the user evaluation and can suggest more appropriate and optimal solution strategies. Due to the complexity and size of the industrial process, each part requires separate evaluation and balancing of process and business objectives, where human input is critical.

Another aspect of the present disclosure relates to the use of a computer-implemented method, as described above and below, in an industrial plant.

### REFERENCE NUMERALS

100 Computer-implemented method
101 First step of the method
102 Second step of the method
104 Third step of the method
106 Fourth step of the method
202 Operator
204 Process devices
206 Alarms and Events
208 Operator actions
210 Process Values
212 Controller on which the machine learning program is implemented
214 Solution strategies
216 Database
218 HMI
302 Background diagrams
310 Pop up window “detailed review”
320 Pop up window “Action recommender”
321 First proposed step in pop up window “Action recommender”
322 Second proposed step in pop up window “Action recommender”
323 Third proposed step in pop up window “Action recommender”
324 Fourth proposed step in pop up window “Action recommender”
325 Diagram showing course of process value
326 User input: grading overall confidence in pop up window “Action recommender”
327 User input: comment overall confidence in pop up window “Action recommender”
328 User input: open pop up window “detailed review”
400 System

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method for handling a current event in industrial process automation, comprising:
monitoring a process for events and recording manual user action data;
upon occurrence of an event, acquiring the recorded manual user action data regarding manual user actions before, during, and after the occurrence of an event;
learning a procedure for handling an event based on the acquired data;
wherein the learning involves creating and providing a solution strategy and collecting user evaluation data for the provided solution strategy; and
applying the learnt procedure to a currently occurring event.

2. The computer-implemented method according to claim 1, wherein the evaluation data is based on pre-defined process Key Performance Indicator, KPI, criteria.

3. The computer-implemented method according to claim 2, wherein the pre-defined process KPI criteria is one of: time to solve the problem, cost effectiveness, and/or amount of process value, PV, changed.

4. The computer-implemented method according to claim 1, wherein the acquiring data comprises further acquiring data of a system behavior in reaction to the user actions.

5. The computer-implemented method according to claim 1, wherein the evaluation data is based on user-defined criteria, the user-defined criteria comprising at least one of whether the wanted results are achieved or not, whether parameter values converge or not, a time required to obtain the desired process values, and an energy consumption.

6. The computer-implemented method according to claim 1, wherein the evaluation data includes separate ratings for parts of the solution strategy.

7. The computer-implemented method according to claim 1, wherein a frequency of previously chosen solution strategies is evaluated and considered for proposing the solution strategy for the current event.

8. The computer-implemented method according to claim 1, wherein the solution strategy comprises at least one step, and wherein the step is one of: changing a set point, controlling an actuator, defining wait time intervals and checking a final process result.

9. The computer-implemented method according to claim 8, wherein the process value is at least one of the following: a fill level, a pressure, a temperature, a current, a voltage, a fluid mixing state, an actuator state, a system state.

10. The computer-implemented method according to claim 9, wherein additionally alternative solution strategies are proposed.

11. A system comprising a controller configured to handle a current event in industrial process automation according to a method, the method comprising:
monitoring a process for events and recording manual user action data;
upon occurrence of an event, acquiring the recorded manual user action data regarding manual user actions before, during, and after the occurrence of an event;
learning a procedure for handling an event based on the acquired data;
wherein the learning involves creating and providing a solution strategy and collecting user evaluation data for the provided solution strategy; and
applying the learnt procedure to a currently occurring event.

12. The system according to claim 11, wherein the evaluation data is based on pre-defined process Key Performance Indicator, KPI, criteria.

13. The system according to claim 12, wherein the pre-defined process KPI criteria is one of: time to solve the problem, cost effectiveness, and/or amount of process value, PV, changed.

14. The system according to claim 11, wherein the acquiring data comprises further acquiring data of a system behavior in reaction to the user actions.

15. The system according to claim 11, wherein the evaluation data is based on user-defined criteria, the user-defined criteria comprising at least one of whether the wanted results are achieved or not, whether parameter values converge or not, a time required to obtain the desired process values, and an energy consumption.

16. The system according to claim 11, wherein the evaluation data includes separate ratings for parts of the solution strategy.

17. The system according to claim 11, wherein a frequency of previously chosen solution strategies is evaluated and considered for proposing the solution strategy for the current event.

18. The system according to claim 11, wherein the solution strategy comprises at least one step, and wherein the step is one of: changing a set point, controlling an actuator, defining wait time intervals and checking a final process result.

19. The system according to claim 18, wherein the process value is at least one of the following: a fill level, a pressure, a temperature, a current, a voltage, a fluid mixing state, an actuator state, a system state.

20. The system according to claim 19, wherein additionally alternative solution strategies are proposed.
